(19) United States
(12) Patent Application Publication
(10) Pub. No.: US 2007/0265949 A1
(43) Pub. Date: Nov. 15, 2007

(54) Method and system for video communication

(76) Inventor: Richard Elder, New York, NY (US)

Correspondence Address: KILPATRICK STOCKTON LLP, 607 14TH STREET, N.W., WASHINGTON, DC, 20005, US

(21) Appl. No.: 11/785,179

(22) Filed: Apr. 16, 2007

Related U.S. Application Data
(60) Provisional application No. 60/792,348, filed on Apr. 17, 2006.

(51) Int. Cl. G06Q 40/00

(52) U.S. Cl. 705/35

(57) ABSTRACT

A customer sales and service tool and methodology for authenticating a customer and identifying and connecting a specific subject matter expert to the customer via live, two-way video communication to address the customer's needs regarding a specific financial product.

### CROSS REFERENCE TO RELATED APPLICATIONS

The present application claims priority to and incorporates by reference in its entirety copending U.S. provisional patent application Ser. No. 60/792,348 filed Apr. 17, 2006.

### FIELD OF THE INVENTION

The present invention relates generally to a communication method and system. More particularly, but not by way of limitation, the present invention is a method and system for video communication. Even more particularly, but not by way of limitation, the present invention is a customer sales and service tool and methodology for authenticating a customer and quickly identifying and connecting a specific subject matter expert to the customer via live, two-way video communication to address the customer's needs regarding a specific financial product.

### BACKGROUND OF THE INVENTION

Each customer relationship has many different facets. Differentiation over time depends on shopping motivation, particular service or purchase occasion, and a variety of other variables that can drive the customer's decision-making process. Traditionally, the process for selling and servicing a customer has been predominantly face-to-face or over the phone or the Internet. In phone and, more particularly, face-to-face communication, when a customer speaks to a sales representative, the representative may be overwhelmed by the broad scope of questions raised by the customer. This is especially true when the representative is expected to have knowledge of specific regulations and provide in-depth information on many diverse products. When a representative is not able to provide immediate answers, customers may become upset and frustrated. Customers often want the personal experience of face-to-face interaction and do not understand why after buying a product at one place, they cannot be serviced as well as they expected at the same location. On the other hand, especially from a cost perspective, an organization cannot reasonably be expected to have all of its experts stationed at all times in each location to personally service its customers.

Accordingly, there is a need for a system and method for providing a customer a face-to-face type of experience with subject matter experts who could best serve the customer's needs in a cost effective manner.

### SUMMARY OF THE INVENTION

The multitude of products and features available through a large organization, such as a financial services company, make it virtually impossible for one individual or even a group of individuals to be fully conversant in all the nuances necessary to properly service a customer. The present invention makes it possible to effectively complete more complicated service transactions by having a team of well-trained professionals who are “beamed” into any location as necessary. In addition, embodiments of the present invention enables any division's products to be serviced at any other division's location. Further, embodiments of the present invention may be placed at large corporate customers and even high net worth private bank customer locations. Embodiments of the present invention also allow customers to reach the right expert by having the same capability on their home personal computer, their office computer or even at non-financial locations, such as, malls, retail locations, etc. The present invention solves the customer's issue “once and done” as opposed to having the customer come back at a later time.

An embodiment of the present invention is a two-way communications vehicle that provides instant or quick access to the right expert at the right point in time, thereby converting what might otherwise be a negative customer experience into a positive sales and service opportunity. As an added benefit, embodiments of the invention have a multitude of other cost effective uses (Training, Communications, Security, Acquisition Support, Remote Customer Identification, Remote Sales and Service, etc.), which enhance an organization's value. Embodiments of the present invention may be voice only, video only, or both voice and video with texting and email capabilities.

Another embodiment of the invention provides an effective natural customer experience through true two-way television. In a further embodiment, unlike other two-way video sources, the present invention offers two-way broadcast quality video without video or voice latency. In addition, embodiments of the present invention have many other features including the ability to function in a call center-like environment.

A further embodiment of the present invention includes video at 30 frames per second, constant, and provides the ability to put somebody who has the right expertise in front of a customer at the touch of a button. A customer (or a representative helping the customer) can, for example, in a banking context, touch “Mortgage,” “Brokerage,” “Cash Management for Business,” etc. to connect with the right expert. On the other end is an expert that the customer is able to see face-to-face via video in a manner that the customer would actually feel he/she is speaking to someone in person. The customers would also have the choice to be helped in the language of their choice, e.g., English or Spanish.

Another embodiment of the present invention verifies, authenticates, and/or otherwise identifies the user. Although verifying a user remotely with traditional methods is not easy—it is not even easy face-to-face, an embodiment of the present invention conducts facial and/or voice recognition to identify the user without having to ask for personal information. Recognizing and addressing a user upon first view, without having to ask probing questions enhances the customer's experience. Furthermore, embodiments of the present invention integrates facial recognition and/or voice recognition such that the customer's information appears on representative's screen. Additionally, the user may see on his/her screen descriptive data regarding the representative.

### BRIEF DESCRIPTION OF THE DRAWINGS

The present invention will be described with reference to the accompanying drawings, wherein:

FIGS. 1A-B illustrate a system architecture of an embodiment of the present invention;

FIG. 2 illustrates an embodiment of the invention utilizing facial recognition;

FIG. 3 illustrates an embodiment of the invention utilizing split screen features;

FIG. 4 illustrates an embodiment of the invention providing multipoint capabilities;

FIG. 5 illustrates an embodiment of the invention incorporating a call center;

FIG. 6 illustrates an embodiment of the invention for selecting a subject matter expert; and

FIG. 7 is a flow chart of an embodiment of the invention.

### DETAILED DESCRIPTION

Reference will now be made in detail to embodiments of the invention. Each example is provided by way of explanation of the invention, not as a limitation of the invention. It will be apparent to those skilled in the art that various modifications and variations can be made in the present invention without departing from the scope or spirit of the invention. For instance, features described as part of one embodiment can be used on another embodiment to yield a still further embodiment. Thus, it is intended that the present invention cover such modifications and variations that come within the scope of the invention.

The present invention expands the reach of specialists, allowing them to interface with more customers at the point in time when their sales and service expertise can mean the difference between cementing a client relationship or losing the business to a competitor. Embodiments of the present invention remove the geographical barriers that prevent an organization's branch personnel from tapping a specialist's knowledge in essentially real time and do so in an environment that embraces the customer in the process. With the present invention “expert customer advice” need not be customers speaking to a disembodied voice over the telephone. Neither will the customer have to accept, “I'll get back to you once I have spoken with one of our specialists” as an answer to a query made at a branch location. Instead, for example, the customer is able to meet directly with specialists in an electronic environment that creates a virtual meeting experience in which the customer will feel as if he or she is sitting across a desk from the specialist. Except for a physical handshake, an organization's specialists are able to bring the full range of their talent, knowledge and experience to the customer at the branch level. Note that the term “real-time” as used herein encompasses near real-time.

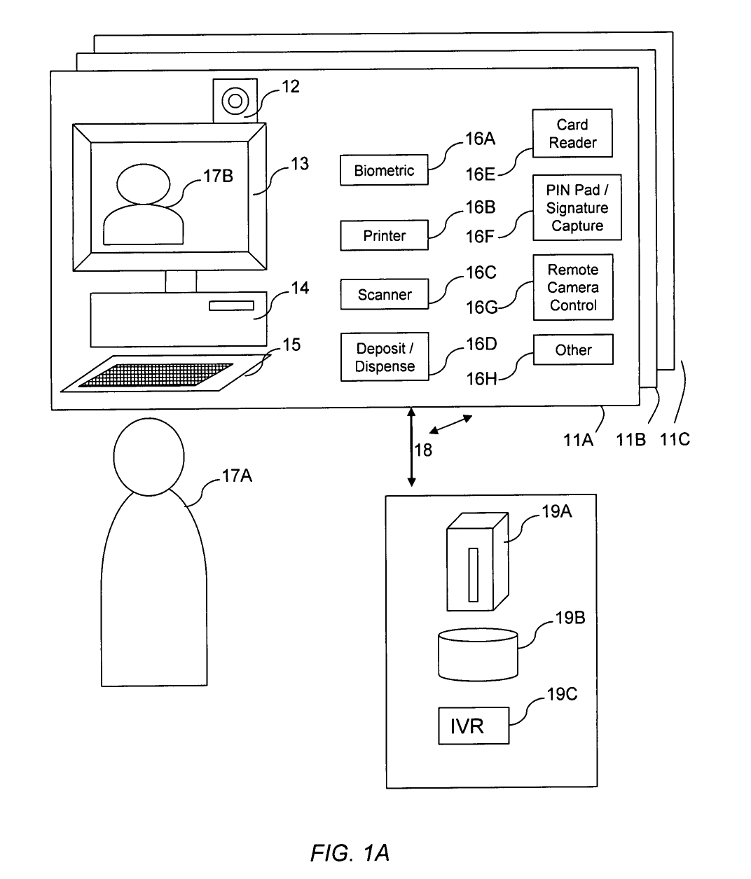

FIG. 1A illustrates a system architecture for an embodiment of the present invention. Included are interface devices 11A-C, such as, personal computers, tablets, automated teller machines (ATMs), kiosks, personal digital assistants (PDAs), wireless devices, video phones, etc. Associated devices include video cameras 12, monitors (with speakers) 13, processors (along with software to carry out the processes) 14, input devices 15 (e.g., keyboard, touch screen), biometric devices 16A (e.g., for fingerprints, iris scan, facial recognition, voice recognition), printers 16B, scanners 16C, deposit/dispense devices 16D, card readers 16E, PIN pads/electronic signature capture 16F, remote camera controls 16G, and other devices 16H, without limitation. Users 17A-B of the interface devices include entities, such as, existing and prospective customers, service and sales agents, employees, managers, groups of individuals, etc., without limitation. Communication networks 18 link the interface devices, servers (including processors, software, etc.) 19A, and databases 19B. The communication networks may include, without limitation, the Internet, intranets, wireless networks, existing telephone networks, etc. FIG. 1B illustrates an embodiment of the two-way video communication process between a customer and a subject matter expert as users of the system.

An embodiment of the system provides for the delivery of real-time or near real-time, two-way, broadcast quality video. The video provided to system users include full duplex video and audio at a sustained rate, as one example, of 30 frames (60 fields) per second fully interlaced in both point-to-point and multipoint environments. The capability also includes lower levels of video and audio quality if the customer is using the service from home or office at lower connection speeds.

The interface 11 may include a “Mini Branch,” affiliated with a system, such as, an automated teller machine (ATM) system. Additionally, the interfaces 11 may be located in a bank, home, office, and other non-bank channel locations, such as, bank-at-work locations. An embodiment of the “Mini Branch” system takes deposits, give cash, open accounts, service accounts, etc. while interacting with a customer 17A through live, two-way video.

Embodiments of the present invention may incorporate legacy systems. Although users may be working with distinct legacy systems, the present invention enables users with different systems to convey a cohesive and integrated presence. Certain embodiments of the present invention operate similar to a switching system, such as a private branch exchange (PBX). The invention searches and finds, for example, the next available expert 17B who is capable of servicing a customer 17A.

In an embodiment of the present invention, input devices 15, such as touch screens are provided to allow a user 17A to respond to questions, such as, “Do you want to speak to someone about mortgages?” The user may select, for example, “yes” which would take him/her to a mortgage expert and engage the expert through live two-way video. Embodiments of the present invention also incorporate voice recognition and interactive voice response 19C such that the user 17A may simply say, e.g., “obtain a mortgage,” “service a mortgage,” or “obtain a home equity loan.”

A further embodiment of the present invention includes a walk-around tablet using wireless communication that serves as an interface 11. A service officer is able to walk around with a tablet and if a customer 17A were to walk into a branch, the service officer could use the walk-around tablet to bring a live video of an expert 17B who may be better able to respond to the customer's issue.

Embodiments of the present invention also record and store the two-way video images in a database 19B. The video is stored, for example, digitally and maintained as records for the appropriate amount of time. Storage may be in the form of a hard drive type system and the video may be stored, for example, as MPEG files. In other embodiments, there are printers 16B for the remote printing of documents, ATM cards, etc. and a scanner 16C for the scanning of checks, documents, currency, identification cards, etc. Additional devices include card readers 16E for reading magnetic stripe and/or smart cards, such as credit and debit cards. Additionally, remote camera control 16G is provided such that, for example, a customer agent can zoom in on a customer's document so the customer could show them a specific line item on a statement or a sentence in a letter.

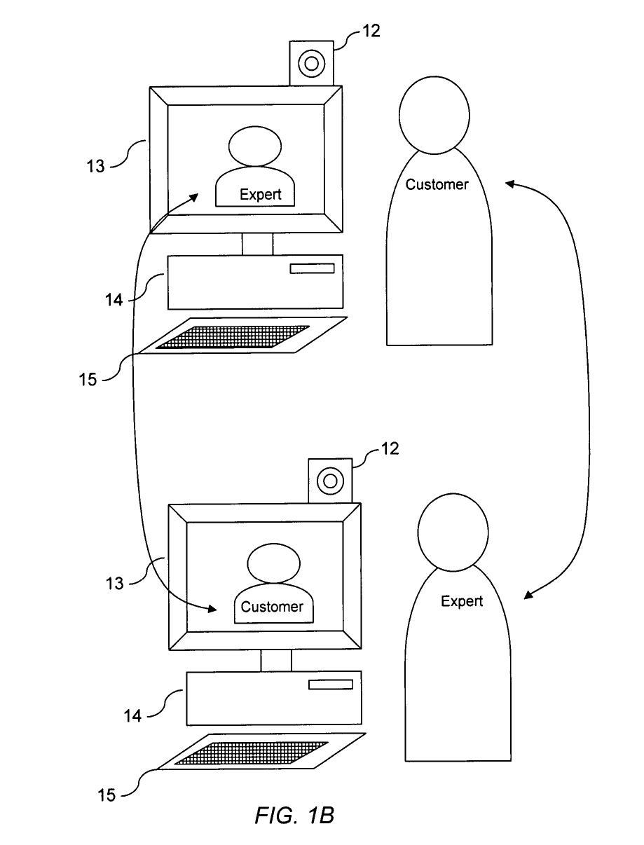

Embodiments of the present invention also include enhanced security and identification capabilities. Referring now to FIG. 2, regarding the identification of a customer 21, unlike voice calls, if a customer's picture 22 is on file, the customer's identification may be verified by seeing him/her on the system rather than inquiring through a series of background questions or, alternatively, both questions and visual identification may be used. This may also be accomplished through a variety or biometric processes that confirms the customer's identity, such as, facial, fingerprint, iris, voice and other verification devices.

In traditional transactions conducted over the phone, a person could falsely identify himself by fraudulently using a mother's maiden name and an account number. With video cameras 23, a person falsely identifying himself could be eliminated with facial recognition technology 24. In an embodiment where cameras are located at a known location, for example, at the entrance of a bank, the facial recognition feature of the present invention identifies customers 21 as they walk into the bank such that when the customer arrives at the teller 25, the teller 25 would have a screen 22 presented for that particular customer 21. Facial recognition 24 is used as opposed to asking for personal information which others in the lobby of the bank could overhear. This immediate service also enhances the customer experience in that the customer 21 can be greeted in a familiar way and can be more quickly assisted.

If the customer 21 is interacting via video with a subject matter expert, the customer 21 may also verify his identification by showing his driver's license. The expert on the other end of the video can actually see the driver's license and compare it to the person's facial image 22. In addition the customer might use an attached scanner 16C to scan an identification card and transmit the information to the expert. That could be a proxy verification. The present invention includes high resolution video to permit such verification. In further embodiments of the present invention that involves the Internet, verification of the identity of a 21 customer can occur at home. Snapshots of customers' forms of identification may be taken so they would not have to come into a branch location.

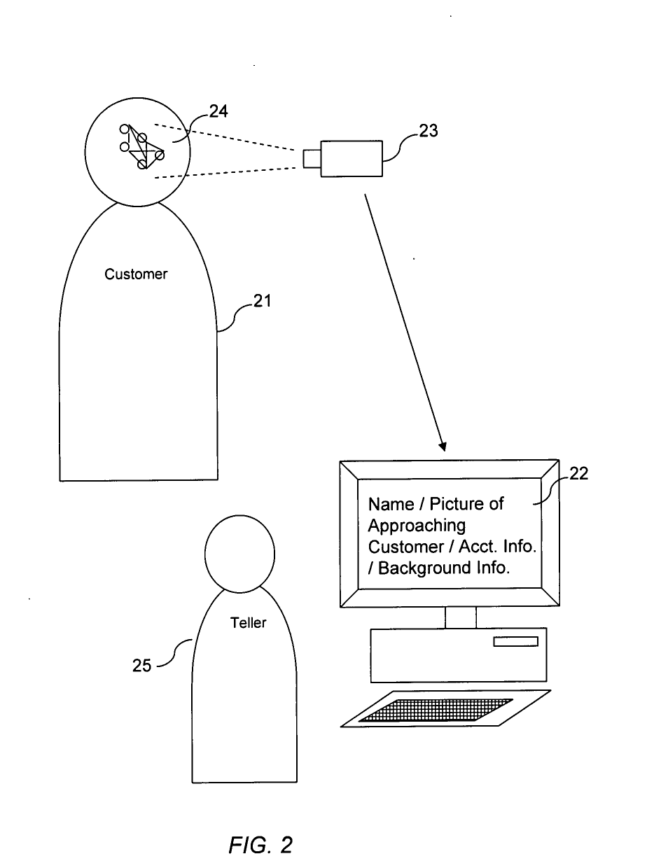

Referring now to FIG. 3, split bandwidth for document collaboration is also provided whereby, for example, PowerPoint presentations or financial simulations or videos (streaming video, DVD, etc.) 31 are demonstrated to a customer along with a live video of the expert 32 speaking to the customer. The video feeds may be from any video source, such as, DVD, VHS, broadcast quality cameras, etc. The expert also may show anything from the expert's personal computer, e.g., live demonstrations of Internet sites. The expert also has the capability to seamlessly handle both video and phone calls from the same desk or interface device thus enhancing the efficiency. The experience to the customer may be just as if he/she is sitting down with the expert face-to-face.

Embodiments of the present invention also provide ways for a representative to review documents with a customer and permit the customer to execute documents and record the execution, as well as, have the executed documents transmitted to the representative in various forms (e.g., fax, email).

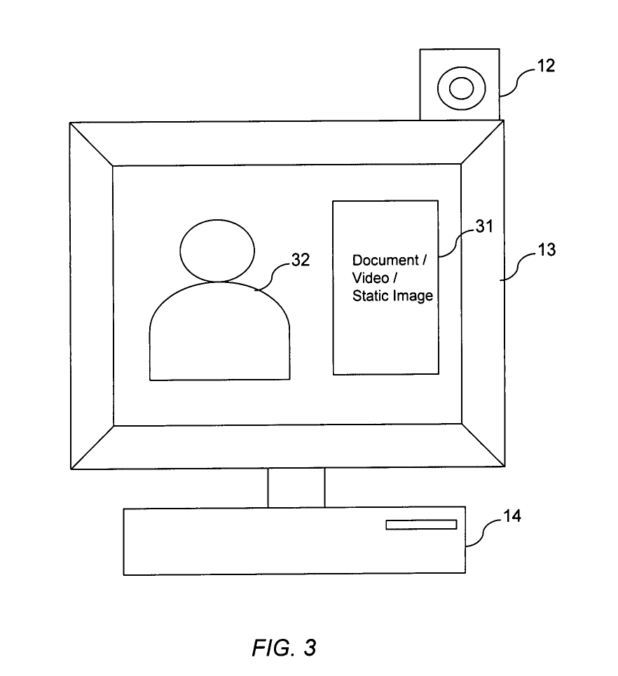

Embodiments of the present invention also provide multipoint capabilities. Referring to FIG. 4, an expert 41 speaking with a customer 42 could bring a second expert 43 onto the screen, perform a warm handoff 44, and then with the customer's permission, leave the session with the second expert taking over the session 45. In addition, one person could broadcast to all individuals on the system, or any number of nodes on the system could be hooked up for a two-way interaction.

Embodiments of the present invention also enable multi-point communication wherein an unlimited number of people may be involved and therefore multiple concerns of a customer, e.g., sales and servicing may be handled during a single customer session. Additionally, if a customer 42 goes into a branch and has a service problem with a checking account, the customer is able to go to a stand-alone terminal and, for example, push the button to “Checking” and get a live video connection to a checking expert 41. If the customer mentions that he is changing addresses, the checking expert may ask, “Why are you changing your address?” The customer may respond, “Well, I've moved because I've just gotten married.” The expert may then say, “Oh, that's wonderful. Tell me, do you have life insurance to protect your spouse and possible future family?” The customer might say, “No, I'd be interested in that.” The checking expert on the other end could then bring up an insurance specialist 43. The insurance specialist 43 and the original expert 41 could then talk to the customer 42, and then the original expert 41 could stay on or drop off the session.

Further, the present invention utilizes intelligent routing. Through the use of facial recognition, for example, information on the customer may be pulled up on by the customer service representative. Embodiments of the present invention provides intelligent routing whereby the system automatically determines who are the best customer service representatives to deal with a particular customer and routes the customer to that sales representative. The routing may be based on a variety of factors, such as, who was the last representative to have interacted with the particular customer.

A Backchannel Voice feature is also provided in embodiments of the present invention. The present invention offers multiple voice channels for private communications. For example, a sales representative 41 interfacing with a customer 42 could be coached 44 in real time without the customer realizing the representative was receiving assistance in the background. Another example may be two senior managers 41, 43 running a multipoint conference with the ability to communicate with each other in private during the call. Should the expert have the need to remove himself from the live video screen, he has the capability to put the customer on hold, showing them a static image or a dynamic screen, e.g., advertisements, and then jump back to the interaction with the customer. In a situation where a customer calls in and gets a busy signal, the customer would be able to leave a video mail, similar to voicemail for phones, for the expert to reach the customer when available.

Embodiments of the invention accept inputs from individuals with other conferencing systems. Additionally, individuals without video technology could still be joined to a session in a voice-only mode.

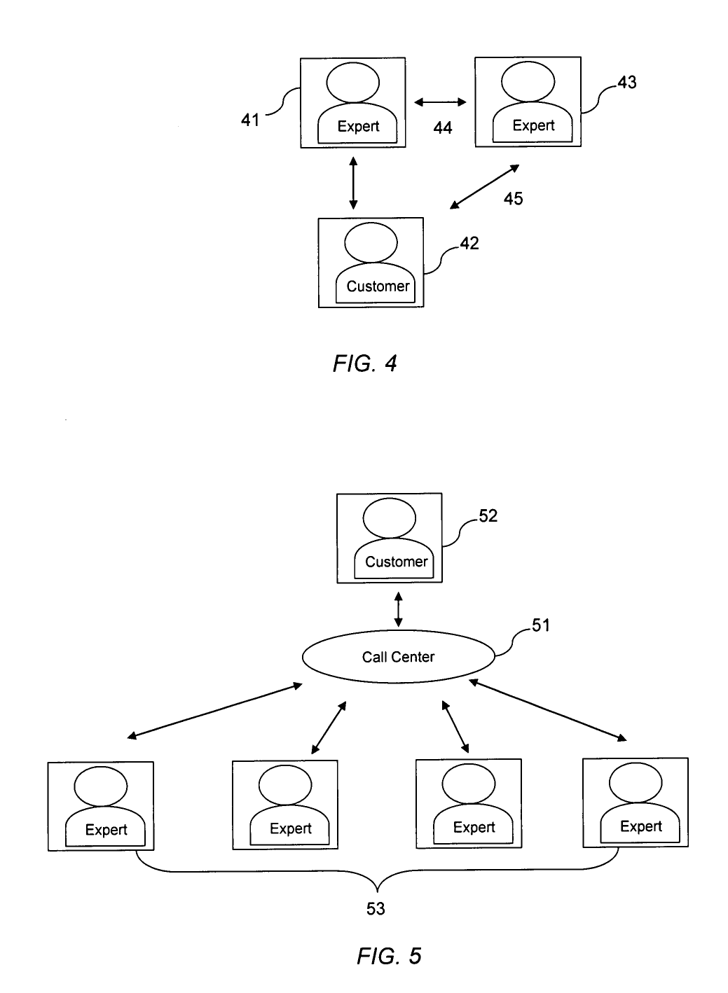

A further embodiment of the present invention includes video services delivered through a call center. Referring now to FIG. 5, the call center 51, for example, may be a communications hub with routing and processing capabilities. The call center 51 receives signals from the originating caller 52 and processes them to the intended destination 53. This structure also provides security and confidentiality. The call center 51 additionally offers the ability to customize various aspects of the video communication process. Engineers at a network operation center can monitor and troubleshoot from the call center 51, as well as, remotely update software to the processing equipment in the field.

Embodiments of the present invention also brings together the various “silos” of an organization to all of the physical locations equipped with the present invention. Furthermore, an embodiment of the invention involves using a call center 51 driven over the Internet. Using Internet based codec, a person over the Internet is able to quickly access the right expert 53 at the desired time.

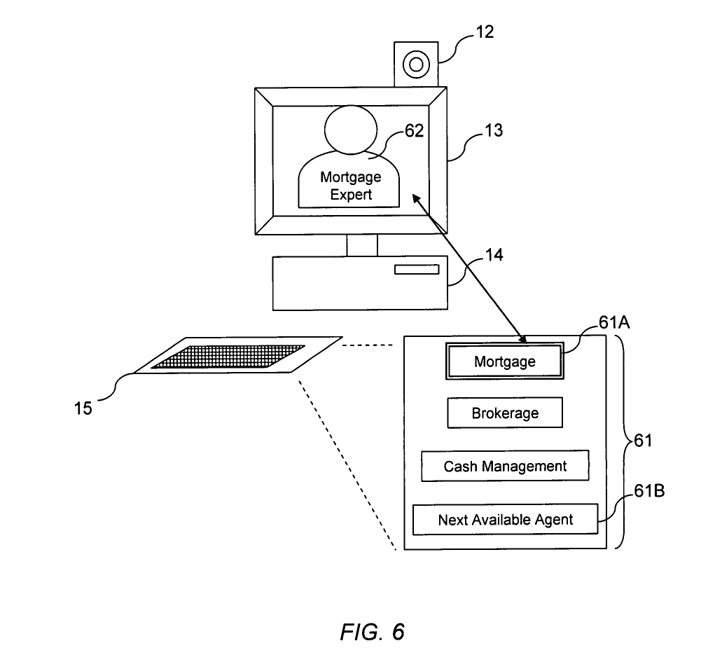

A further embodiment of the invention includes an easy connect access whereby preprogrammed custom menu graphics make reaching the right party or parties as easy as the touch of a button. Referring to FIG. 6, an embodiment of the present invention includes, for example, a screen or keyboard 15 that provides the user with options 61 that user would easily recognize. For example, the display may present two initial options, “Consumer” or “Business.” The user may then touch “Consumer.” From that selection further options are displayed and may include “Checking,” “Mortgage,” “Savings Account,” “Brokerage Accounts,” etc. The user may then select “Mortgage” 61A and there may be further, more specific options to select. At a point where the user has identified his/her area of interest, the appropriate person 62 will appear live on the screen. Further embodiments include a Next Available Agent 61B feature which enables hunting for and calling the next available agent rather than a specific location or exact specialization.

Embodiments of the present invention also permit communications, such as interactive two-way town hall meetings and company meetings where employees could see, hear and interact with senior managers. The present invention also includes an acquisition support application where communications, training, operations support and feedback are provided to locations of newly acquired businesses through conversion periods. Other embodiments include a training feature. The present invention provides a virtual lecture hall for, e.g., employees and their managers. Because of the broadcast quality interactive video communication environment, employees and trainers can interact and exchange ideas creating an education experience that does not require expensive travel or residency commitments.

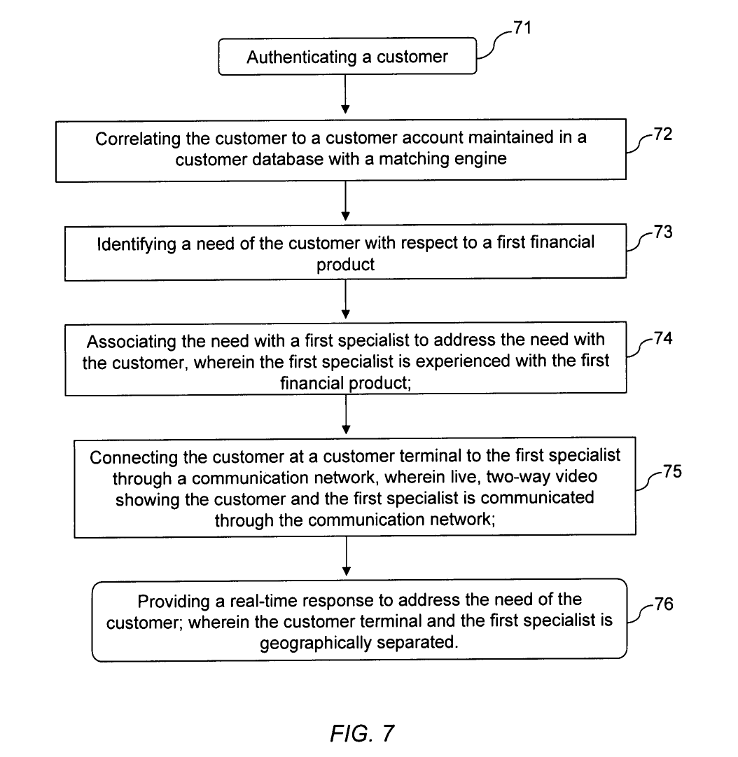

Referring now to FIG. 7, an embodiment of the present invention is a method for responding to a customer through real-time two-way video and voice communication, comprising the steps of: authenticating the customer 71; correlating the customer to a customer account maintained in a customer database 72; identifying a need of the customer with respect to a first financial product 73; associating the need with a first specialist to address the need with the customer, wherein the first specialist is experienced with the first financial product 74; connecting the customer at a customer terminal to the first specialist through a communication network, wherein live, two-way video showing the customer and the first specialist is communicated through the communication network 75; and providing a real-time response to address the need of the customer, wherein the customer terminal and the first specialist is geographically separated 76.

Embodiments of the present invention have now been described. It will be appreciated that these examples are merely illustrative of the invention. Many variations and modifications will be apparent to those skilled in the art.

1. A method for responding to a customer through real-time two-way video and voice communication, comprising the steps of:
authenticating the customer;
correlating the customer to a customer account maintained in a customer database;
identifying a need of the customer with respect to a first financial product;
associating the need with a first specialist to address the need with the customer, wherein the first specialist is experienced with the first financial product;
connecting the customer at a customer terminal to the first specialist through a communication network, wherein live, two-way video showing the customer and the first specialist is communicated through the communication network; and
providing a real-time response to address the need of the customer;
wherein the customer terminal and the first specialist is geographically separated.

2. The method of claim 1 wherein authenticating the customer comprises remotely viewing an identification document and comparing the identification document with an a live image of the customer.

3. The method of claim 1 wherein authenticating the customer comprises comparing real time biometric data of the customer to biometric data stored in a database.

4. The method of claim 3 wherein the biometric data is facial recognition data.

5. The method of claim 1 wherein the step of connecting the customer to the specialist performed by a call center.

6. The method of claim 1 further comprising the step of:
inquiring if the customer is interested in a second financial product; and
passing the customer to a second specialist specializing in the second financial product which has a subject matter different than the first financial product.

7. The method of claim 1 wherein the live two-way video shows the specialist along with a presentation material.

8. The method of claim 1 wherein the customer terminal is an automated teller machine.

9. The method of claim 1 wherein the customer terminal is a personal computer.

10. The method of claim 1 further comprising the step of:
remotely controlling a video camera that provides video for the live two-way video.

11. The method of claim 1 wherein a real time text message from the first specialist or the customer appears on the video.

12. The method of claim 1 wherein identifying a need of the customer with respect to a first financial product comprises the step of:
receiving a selection of the first financial product by the customer from a list of financial products.

13. The method of claim 1 further comprising the step of:
receiving an indication regarding the language with which the customer desires to communicate during the live two-way video.

14. The method of claim 1 wherein the step of correlating the customer to a customer account maintained in a customer account database occurs without active input from the customer.

15. The method of claim 1 wherein identifying a need of the customer with respect to a first financial product comprises the step of:
recognizing a voice command from the customer regarding the first financial product.

16. The method of claim 1 further comprising the step of:
recording an execution of a document by the customer with respect to the first financial product.

17. The method of claim 1 wherein correlating the customer to a customer account maintained in a customer database further comprises the step of:
identifying a specialist that has a prior interaction with the customer.

18. A system for responding to a customer through real-time two-way video and voice communication, comprising:
authenticating means for authenticating the customer;
correlation means for correlating the customer to a customer account maintained in a customer database;
identification means for identifying a need of the customer with respect to a first financial product;
association means for associating the need with a first specialist to address the need with the customer, wherein the first specialist is experienced with the first financial product;
connection means for connecting the customer at a customer terminal to the first specialist through a communication network, wherein live, two-way video showing the customer and the first specialist is communicated through the communication network; and provides a real-time response to address the need of the customer;
wherein the customer terminal and the first specialist is geographically separated.

19. A system for responding to a customer through real-time two-way video and voice communication, comprising:
a biometric device for authenticating the customer;
a processor, wherein the processor correlates the customer to a customer account maintained in a customer database;
an input device receiving an identification of a need of the customer with respect to a first financial product;
a matching engine associating the need with a first specialist to address the need with the customer, wherein the first specialist is experienced with the first financial product;
a communications network connecting the customer at a customer terminal to the first specialist, wherein live, two-way video showing the customer and the first specialist is communicated through the communication network; and
an interface device providing a real-time voice and video response to address the need of the customer, wherein the customer terminal and the first specialist is geographically separated.

20. The system of claim 19 further comprising:
a switching component for passing the customer to a second specialist specializing in a second financial product which has a subject matter different than the first financial product.
